(19) United States
(12) Patent Application Publication
(10) Pub. No.: US 2007/0199391 A1
(43) Pub. Date: Aug. 30, 2007

(54) Apparatuses And Methods For Pumping Fluids

(76) Inventor: George E. Fourqurean, Midland, TX (US)

Correspondence Address: CRUTSINGER & BOOTH, 1601 ELM STREET, SUITE 1950, DALLAS, TX, 752014744, US

(21) Appl. No.: 10/599,362

(22) PCT Filed: Mar. 29, 2005
(86) PCT No.: PCT/US05/10268

§ 371 Date: Sep. 26, 2006

Related U.S. Application Data
(60) Provisional application No. 60/557,187, filed on Mar. 29, 2004.

(51) Int. Cl. F16H 21/00

(52) U.S. Cl. 74/25

(57) ABSTRACT

Apparatuses and methods are provided for transferring axial rotational motion of a drive shaft to linear reciprocating motion to drive a piston, for example in a fluid pump. The apparatus includes a cam having: a generally cylindrical body portion; and a drive-shaft connector, wherein the drive-shaft connector is: adapted to be part of an operable connection between the drive shaft and the cam, and located along an eccentric axis of the cam. The apparatus includes a plurality of bearings, wherein the plurality of bearings are operatively positioned around the cam. The apparatus also includes a planetary, wherein the planetary includes: a generally cylindrical opening adapted to be operatively positioned around the plurality of bearings; and a follower connector, wherein the follower connector is adapted to be part of an operable connection transferring a component of the circular orbital motion of the planetary to the linear reciprocating motion of the piston. Also provided is an improved pump and improved discharge valve assembly for pumping fluids.

### TECHNICAL FIELD

The apparatuses and methods relate to pumping fluids. More particularly, the apparatuses and methods of the inventions relate to driving a reciprocating piston (or plunger) of a fluid pump. In other aspects, the apparatuses and methods relate to an improved pump block, including an improved piston assembly and/or an improved discharge valve assembly.

### BACKGROUND OF THE INVENTION

It is well known in the art of pumping fluids to use a cam for converting axial rotational motion of a drive shaft to a linear reciprocating motion to drive a piston. Conventionally, a cam is used to knock a follower from side to side. A piston is attached to the follower. This arrangement, however, results in a great deal of wear and tear between the cam and the follower, at the expense of reliability and at the expense of maintenance costs.

It is also well known in the art to use a scotch yoke for converting axial rotational motion of a drive shaft to a linear reciprocating motion to drive a piston. This arrangement has two rotational linkages that are subject to highly concentrated mechanical stresses. This arrangement also results in a great deal of wear and tear between the linkages, at the expense of the reliability of maintenance costs. U.S. Pat. No. 1,301,485 issued Apr. 22, 1919 having for named inventor Hilmar Mueller discloses a pump having a shaft secured by a set screw to rotate an eccentric encircled by a strap that has connection through a wrist pin to impart reciprocatory movement to pistons of a diaphragm pump. U.S. Pat. No. 4,078,439 issued Mar. 14, 1978 having for named inventor Luis Iturriaga-Notario discloses an alternative reciprocating compressor having a driving shaft that is solidly fastened to a circular eccentric with externally, and by means of a ball or roller bearing is enclosed by another eccentric which is also circular and is also provided at its external rim with a ball or roller bearing. The other eccentric at its outer path incorporates, at diametrically opposed points extensions to which plungers are joined, in such a way that the turn of a driving shaft originates alternative rotating slidings of one eccentric with respect to the other thus causing the successive approximation and separation of the geometrical axes pertaining to the enclosing eccentric and the driving shaft within a plan comprising the longitudinal axes of the plungers, which imparts a reciprocating movement to said plungers. See U.S. Pat. No. 4,078,439, Abstract and Claim 1 thereof.

There has been a long-felt need for apparatuses and methods for driving a reciprocating piston (or plunger) of a fluid pump that are more efficient, more reliable, and having less wear and tear on mechanical parts. These needs are especially acute when it is desirable to pump fluids at higher pressures and/or in remote locations, where reliability is at a premium because the remoteness makes travel to the site to make repairs more costly.

It is also well known in the art to use seals and bushings for the piston (or plunger) of a fluid pump. However, these seals and bushings have been difficult to disassemble and reassemble during maintenance. There has been a long-felt need for apparatuses and methods for easing the manipulations required for disassembling and reassembling the seals and bushings for the piston bore of a fluid pump.

It is further well known in the art to use a one-way check valve to control fluid flow in the suction and discharge sides of a fluid pump. In high-pressure applications, however, the conventional check valve tends to leak from the high pressure side of the pump back through the discharge valve into the pumping chamber. This reduces the efficiency of the pump. There has been a long-felt need for a discharge valve assembly that is less susceptible to leaking high pressure fluid back into the pumping chamber.

In general, there are many applications for pumping fluids. For example, one type of pump that has a particular need for a solution to these kinds of problems with the prior art pumps is in solar power injection pump applications, such as described in U.S. Pat. No. 6,293,892, issued on Mar. 15, 1994 to George Fourqurean (named inventor herein), which is incorporated herein by reference in its entirety.

The types of pumps useful in solar powered injection applications, among other applications, include a fluid pump of the type described in U.S. Pat. No. 6,257,843 issued Jul. 10, 2001 to James E. Cook and O. Harald S. Eriksen, which is incorporated herein by reference in its entirety; a fluid pump as described in U.S. Pat. No. 6,527,524 issued Mar. 4, 2003 to James E. Cook, which is incorporated by reference in its entirety; and a fluid pump as described in U.S. Design Pat. No. D436,968 issued Jan. 30, 2001 to James E. Cook, which is incorporated by reference herein in its entirety.

### SUMMARY OF THE INVENTION

According to a first aspect of the inventions, an apparatus for converting an axial rotational motion of a drive shaft to a linear reciprocating motion to drive a piston is provided. The apparatus includes (a) a cam, wherein the cam comprises: a generally cylindrical body portion; and a drive-shaft connector, wherein the drive-shaft connector is: adapted to be part of an operable connection between the drive shaft and the cam, and located along an eccentric axis of the cam, whereby the axial rotational motion of the drive shaft can be transferred to an eccentric rotational motion of the cam; (b) a plurality of bearings, wherein the plurality of bearings are operatively positioned around the cam, whereby eccentric rotational motion of the cam can be converted to an eccentric orbital motion of the plurality of bearings; and (c) a planetary, wherein the planetary comprises: a generally cylindrical opening adapted to be operatively positioned around the plurality of bearings, whereby the eccentric orbital motion of the plurality of bearings can be converted to a circular orbital motion of the planetary; and a follower connector, wherein the follower connector is adapted to be part of an operable connection transferring a component of the circular orbital motion of the planetary to the linear reciprocating motion of the piston.

According to a second aspect of the invention, a fluid pump is provided. The piston bore of the pump has a bushing retainer with an aperture, wherein the bushing retainer is adapted to slide into a corresponding slot formed in the pump body, whereby the bushing is securely retained in the piston bore.

According to a third aspect of the invention, an improved discharge valve is provided. The discharge valve is a one-way check valve with a retaining washer. The retaining washer is adapted to accommodate an o-ring seal. During fluid suction into the pump, relatively-high pressure fluid from the discharge side of the pump acts on the high-pressure side of the poppet in the discharge valve to cause it to close against the retaining washer and its o-ring. The retaining washer and o-ring provide a seal against fluid leaking back into the pumping chamber.

These and further aspects and advantages of the invention will become apparent to persons skilled in the art from the following drawings and detailed description of presently most-preferred embodiments of the invention. These and further aspects of the invention are most advantageously and synergistically practiced together.

### BRIEF DESCRIPTION OF THE DRAWING

The accompanying drawings are incorporated into and form a part of the specification to illustrate several examples of the present inventions. These drawings together with the description serve to explain the principles of the inventions. The drawings are only for illustrating preferred and alternative examples of how the inventions can be made and used and are not to be construed as limiting the inventions to the illustrated and described examples. The various advantages and features of the present inventions will be apparent from a consideration of the drawings in which:

FIG. 1 is a front elevation view of a pump according to the presently most-preferred embodiment and best mode known for practicing the invention;

FIG. 2 is a top plan view of the pump shown in FIG. 1;

FIG. 3 is an enlarged font-elevation view with partial cut-away of a portion of the apparatus illustrated in FIG. 1, showing in more detail the presently most-preferred embodiment and best mode known of an apparatus for converting axial rotational motion of a drive shaft to linear reciprocating motion to drive a piston;

FIG. 4 is a top plan view of the apparatus shown in FIG. 3;

FIG. 5 is an exploded perspective view of the apparatus shown in FIGS. 3 and 4, showing the cam, the plurality of bearings, and the planetary, among other things;

FIG. 6 is an exploded perspective view of the bearing assembly shown in FIG. 5;

FIG. 7 is an exploded perspective view of a first alternative embodiment of the apparatus shown in FIG. 5, wherein the bearing assembly between the cam and the planetary is modified;

FIG. 8 is a perspective view of a second alternative embodiment of the apparatus shown in FIG. 5, wherein the follower connector is a pin on the planetary and the follower has a receiving bore for the pin;

FIG. 9 is a perspective view of a third alternative embodiment of the apparatus shown in FIG. 5, wherein the follower connector and follower are modified to be a rib and slot;

FIG. 10 is a front elevation view of a fourth alternative embodiment of the apparatus shown in FIG. 5, wherein the planetary has a second follower connector;

FIG. 11 is a front cross-section view of a pump according to the presently most-preferred embodiment and best mode known for practicing the second and third aspects of the invention, showing the interior of the piston bore of the pump body and the interior of discharge valve assembly;

FIG. 12 is an end view of the pump shown in FIG. 11, illustrating the bushing retainer slot;

FIG. 13 is a perspective view of the bushing retainer shown in FIG. 11;

FIG. 14 is an exploded side and perspective view of the suction valve assembly shown in FIG. 11; and

FIG. 15 is an exploded side and perspective view of the discharge valve assembly shown in FIG. 11.

### DETAILED DESCRIPTION OF PREFERRED EMBODIMENTS

The present inventions will be described by referring to apparatuses and methods showing various examples of how the inventions can be made and used. In these drawings, reference characters are used throughout the several views to indicate like or corresponding parts.

As used herein and in the appended claims, the words “comprise,” “has,” and “include” and all grammatical variations thereof are each intended to have an open, non-limiting meaning that does not exclude additional elements or parts of an assembly, subassembly, or structural element.

As used herein, terms such as “first,” “second,” “third,” etc. are arbitrarily assigned and are merely intended to differentiate between two or more parts that are similar or corresponding in structure and/or function. It is to be understood that the words “first” and “second” serve no other purpose and are not part of the name or description of the following terms. Furthermore, it is to be understood that that the mere use of the term “first” does not require that there be any “second” similar or corresponding part, either as part of the same element or as part of another element. Similarly, the mere use of the word “second” does not require that there by any “third” similar or corresponding part, either as part of the same element or as part of another element, etc.

As many of the parts of the invention are generally ring-shaped or cylindrical, being symmetrical about a circular or cylindrical axis thereof, the term “axial” refers to the geometrical axis of a part having a generally circular or cylindrical shape, such as a ring, opening, race, tubular sleeve, etc. The term “eccentric” means that the circular and/or cylindrical shaped parts or elements are arranged to have parallel but not aligned geometrical axes. Similarly, as many of the parts of the invention structural features are defined in that same context. For example, as used herein, the term “wall” generally refers to the body forming a circumferential surface parallel to a geometrical axis. In addition, the term “lip” or “shoulder” refers to the body forming an annular surface that is perpendicular to the geometrical axis of the element.

For the sake of consistency of usage, once a reference or relational term is arbitrarily assigned to help describe a structure or feature in a particular figure, the term will then be used consistently to refer to like parts throughout the other figures of the drawing. The same reference or relational term is later used even if the orientation of a structure is different in another figure. It is to be understood that, unless the context otherwise requires, the use of such arbitrarily assigned relational or relative terms is not to be construed as unnecessarily limiting the invention.

In general, unless otherwise expressly stated, the words or terms used in this disclosure and the claims are intended to have their ordinary meaning to persons of skill in the art. Initially, as a general aid to interpretation, the possible definitions of the words used herein are intended to be interpreted by reference to comprehensive general dictionaries of the English language published before or about the time of the earliest filing of this application for patent. Where several different general definitions are available, it is intended that the broadest definitions or senses be selected that are consistent with the description of the presently most-preferred embodiments of the invention, including without limitation as shown in the drawings.

After initially consulting such general dictionaries of the English language, it is intended that the words or compound terms be further defined or the most appropriate general definition or definitions be selected by consulting engineering dictionaries, encyclopedias, treatises, and relevant prior art to which this invention pertains. Finally, if necessary to resolve any remaining doubt, utilizing the patent record may be helpful to select from the possible definitions.

Of course, terms made up of more than one word (i.e., compound terms), such as “piston bore,” may not be found in general dictionaries of the English language. Compound terms are intended to be interpreted as a whole, and not by parsing the separate words of the compound term, which might result in absurd and unintended interpretations. In general, compound terms are to be interpreted as they would be understood in the art, consistent with the usage in this specification and with reference to the drawings.

It is intended that examining relevant general dictionaries, encyclopedias, treatises, prior art, and the patent record will make it possible to ascertain the appropriate meanings that would be attributed to the words and terms of the description and claims by those skilled in the art, and the intended full breadth of the words and terms will be more accurately determined. In addition, the improper importation of unintended limitations from the written description into the claims will be more easily avoided.

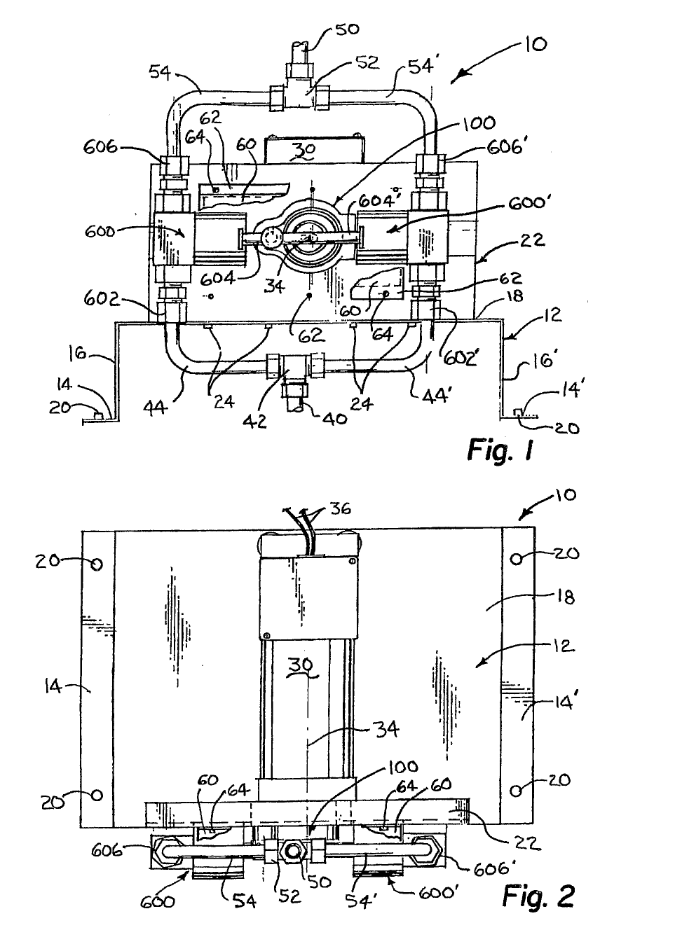

Referring now to FIGS. 1 and 2, a dual fluid pump assembly, generally referred to by the reference numeral 10, is shown.

Preferably, the pump assembly 10 has a support frame 12. The support frame 12 has, for example, a lower left flange 14 and a lower right flange 14′, a left side 16 and a right side 16′, and a horizontal support 18. The flanges 14 and 14′ of the frame 12 can be secured to another support structure (not shown), for example by a plurality of bolts 20. An upright block 22 is preferably secured to the horizontal support 18, for example by a plurality of bolts 24. It is to be understood, of course, that the frame 12 and the upright block 22 are illustrative only, not critical to the practice of the inventions, and that many other frame structures and configurations can be employed as desired or appropriate under the circumstances.

A motor 30 is mounted to the support surface 18 of the frame 12, for example, by bolts (not shown). A drive shaft 32 of the motor 30 (not shown in FIGS. 1 and 2) is positioned to revolve about its rotational axis 34 and can be supported, for example, to extend through the upright block 22. The motor 30 can be powered by any convenient energy source. The motor 30 can be electric powered, for example, through electric leads 36. The electric leads can be connected to a DC battery (not shown) or an AC electrical power source (not shown), as the case may be. In remote locations, for example, it may be desired to have one or more solar panels (not shown in the drawing) for charging a battery.

The drive shaft of the motor 32 (not shown in FIGS. 1 and 2) is connected to a converting assembly 100 for converting the axial rotational motion of the drive shaft to linear reciprocating motion to drive a piston of one or more fluid pumps, such as left fluid pump 600 and right fluid pump 600′. The converting assembly 100 and the pumps 600, 600′ will hereinafter be described in detail, but in general, each of the pumps, 600, 600′ has a suction valve port fitting 602, 602′, a pistons 604, 604′, and a discharge valve port fitting 606, 606′, respectively.

A fluid intake line 40 can be fluidly connected to any desired fluid source (not shown) that may be desired to be pumped. For the dual pump assembly 10 shown in FIGS. 1 and 2, the intake line 40 can be split via a the Y-fitting 42 into diverging lines 44 and 44′, which are connected to the suction valve port fittings 602, 602′, respectively. The fluid discharge line 50 can be fluidly connected to any discharge outlet (not shown). For the dual pump assembly 10, the discharge line 50 can be merged via the Y-fitting 52 to receive discharged fluid from both pumps 600, 600′ via merging lines 54, 54′. Of course, other fluid pumping configurations are contemplated, such as using the dual pump 10 to pump two different fluid sources to the same or two different fluid outlets.

Preferably, a cover 60 is included to protect the converting assembly 100 and the pumps 600, 600′ from the weather or any other types of interference. The cover 60 can be secured to the upright block 22, for example at flanges 62 by a plurality of suitable screws or bolts 64.

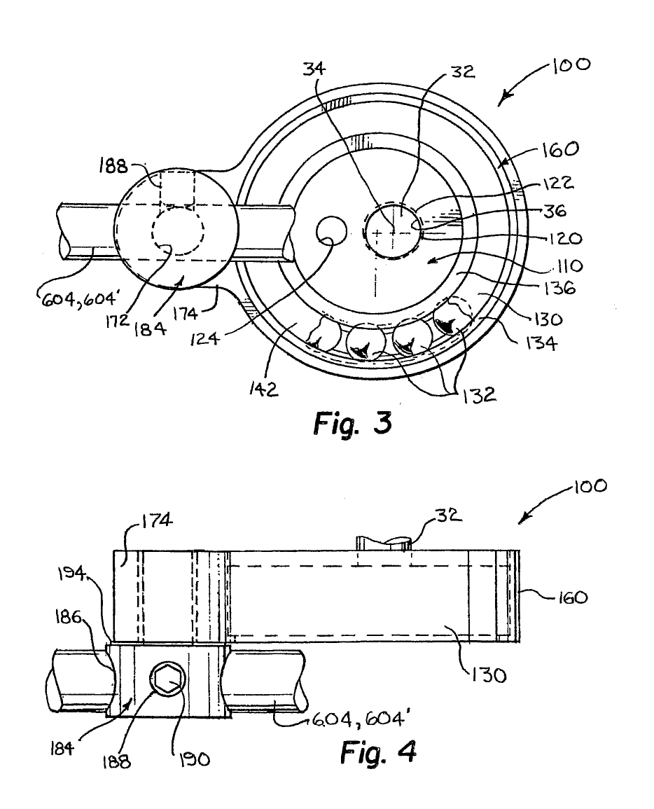

Referring now to FIGS. 3-5, the converting assembly 100 will be described in detail. In general, the converting assembly 100 includes a cam 110, a bearing assembly 130, and a planetary 160. In general, the cam includes a drive-shaft connector 120; the bearing assembly 130 includes a plurality of bearings, preferably ball bearings 132; and the planetary 160 includes a generally cylindrical opening 162 adapted to be operatively positioned around the plurality of bearings; and a follower connector 170.

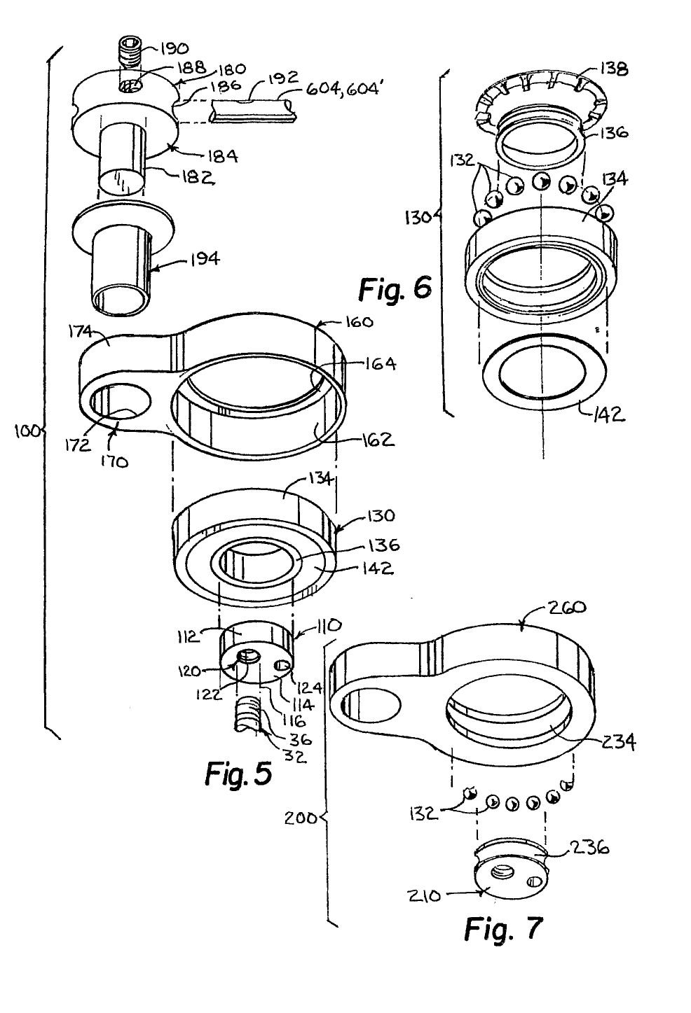

As best shown in FIG. 5, the cam 110 is generally cylindrical body in shape, having cylindrical wall 112 and end walls 114, defining an axis 116.

As best shown in FIGS. 3 and 5, the cam has a drive-shaft connector 120, wherein the drive-shaft connector is: adapted to be part of an operable connection between the drive shaft 32 and the cam 110, and located along an eccentric axis of the cam 110. The drive-shaft connector 120 preferably comprises: a female threaded bore 122 in the cam 110. The a drive shaft 32 preferably has a male threaded end 36, the male threaded end 36 corresponding to the female threaded bore 122 in the cam. Most preferably, the drive shaft 32 rotates in the opposite direction to the handedness of the threaded connectors of the cam and the drive shaft, whereby the rotation of the drive shafts 32 tends to maintain the threaded connection. This helps prevent the rotation of the drive shaft 32 from unintentionally loosening the threaded connection.

However, for maintenance it can be desirable to be able to remove the cam 110 from the drive shaft 32. For this purpose, the cam 110 preferably further comprises: a second bore 124 in the cam 110, wherein the second bore 124 has an axis that is eccentric to the female threaded bore 120 in the cam, whereby a rod (not shown) can be inserted into the second bore 124 of the cam for knocking and loosening a threaded connection between the drive shaft 32 and the cam 110.

As best shown in FIGS. 3 and 5, according to the presently most-preferred embodiment, a bearing assembly 130 is positioned around the cam 110. This is the preferred example of how a plurality of bearings 132 can be positioned around the cam 110. Most preferably, the plurality of bearings comprise ball bearings.

A presently most-preferred embodiment of the bearing assembly 130 is shown in FIG. 6. Preferably, the bearing assembly 130 for the plurality of bearings 132 comprises: an outer race 134 for the plurality of bearings; and an inner race 136 for the plurality of bearings.

Most preferably, the bearing assembly 130 further comprises: a ball cage 138 for the plurality of bearings 132. The ball cage 138 has a plurality of spacers 140 for separating and assisting in guiding the ball bearings 132.

Most preferably, the bearing assembly further comprises: a bearing shield 142. The bearing shield 142 helps protect the bearings 132 from dirt and other particles that can interfere with the smooth running of the ball bearings 132, and helps protect the bearings from water or other environmental materials that can interfere with the lubricant for the bearing assembly 130.

As best shown in FIG. 5, the plurality of bearings 132 in the bearing assembly 130 are preferably operatively positioned around the cam by pressing the cam 110 in an interference fit into the inner race 136 of the bearing assembly 130. Similarly, opening 162 of the planetary 160 is preferably operatively positioned around the plurality of bearings 132 by pressing the outer race 134 of the bearing assembly 130 in an interference fit into the opening 162 of the planetary 160.

Most preferably, the opening 162 of the planetary further comprises a lip 164 for assisting in axially retaining the bearing assembly 130 in the opening.

Continuing to refer to FIGS. 3-5, the follower connector 170 most preferably comprises: a second opening 172 in the planetary 160. Most preferably, the second opening 172 in the planetary 160 is eccentrically located relative to the generally cylindrical opening 162 in the planetary for the plurality of bearings. For example, the second opening 172 can be formed in a lobe 174 extending from the main body of the planetary 160. Most preferably, the second opening 172 in the planetary 160 is generally cylindrical.

Continuing to refer to FIGS. 3-5, the converting assembly can further comprise a follower 180. Preferably, the follower 180 comprises: a pin 182 that is adapted to be received in the second opening 172 of the planetary 160, and a means for engaging a portion of the pistons 604, 604′. According to one embodiment, the means for engaging the piston comprises: a head 184 having piston bore 186 adapted to receive a portion of the piston, and a means for retaining the piston in the piston bore. According to one preferred embodiment, the means for retaining the piston in the piston bore of the follower comprises: a threaded bore 188 in the head 184 perpendicular to the piston bore 186, and a screw 190 adapted to tighten against the potion of the pistons 604, 604′ positioned in the piston bore 186. Most preferably, the pistons 604, 604′ is provided with a recess 192, against which the screw 190 can better engage.

Still referring to FIGS. 3-5, the converting assembly 100 most preferably further comprises: a means for reducing the friction as the pin 182 rocks in the second opening 172 of the planetary 160. According to the presently most-preferred embodiment, the means for reducing the friction as the pin rocks in the second opening of the planetary comprises: a self-lubricating sleeve 194 adapted to be positioned in the second opening 172 in the planetary. Such a sleeve can be made, for example, of Nylatron, a commercially-available material that is suited for self-lubricating purposes. It is to be understood, of course, that alternative means can be used, such as a needle bearing assembly adapted to be positioned in the second opening in the planetary (not shown in FIGS. 3-5).

Now turning to FIG. 7, an alternative embodiment for the bearing assembly is provided. In this case, a cam 210 is provided, similar to cam 110 previously described, but having an inner race 236 for the plurality of bearings that is integrally formed with the generally cylindrical body portion of the cam 210 around which the plurality of bearings are to be operatively positioned. Similarly, in the case a planetary 260 is provided, similar to planetary 160 previously described, but having an outer race 234 for the plurality of bearings that is integrally formed with the planetary 260.

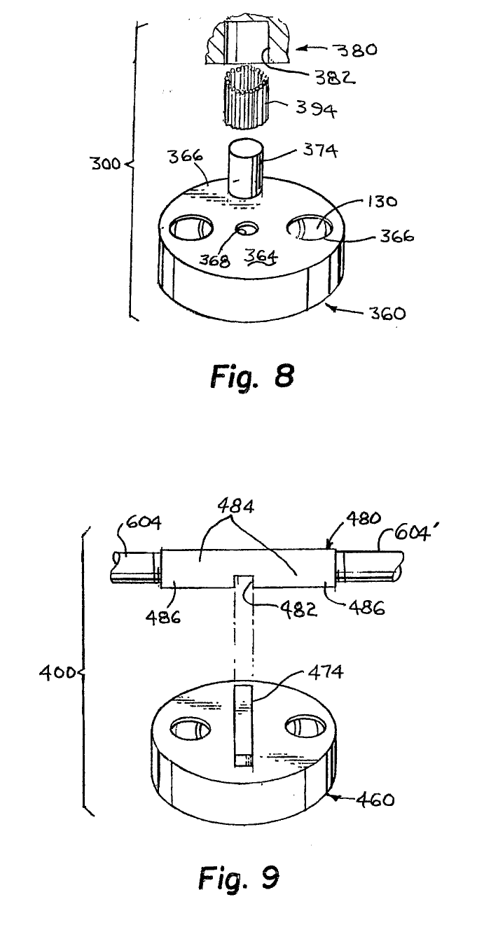

Referring now to FIG. 8 of the drawing, an alternative embodiment of a converting assembly 300 is provided, which is similar to the converting assembly 100 previously described, except that it includes a planetary 360, follower 380, and bearing 394. These elements are similar to corresponding elements previously described, except as noted to illustrate different embodiments of the various elements of the invention.

In one respect, differences in the planetary 360 from the planetary 160 previously described is that the planetary 360 comprises a back 364 for assisting in positioning and axially retaining the bearing assembly 130 in the opening 162 (not visible in this perspective view). The back 364 of the opening of the planetary 360 preferably has one or more apertures 366 for providing access to assist in removing the bearing assembly from the opening. The back 364 of the opening of the planetary 360 preferably also has an alignment aperture 368, which can be rotationally aligned with the aperture 124 of the cam 120 when desired to have access to the aperture 124 (aperture 124 not shown in FIG. 8).

In another difference from the most-preferred planetary 160 previously described, the planetary 360 has a projection, such as pin 374. In this embodiment, the pin 374 is preferably eccentric relative to the opening 162.

The follower 380 comprises: an opening 382 adapted to receive the pin 374, and a means for engaging the piston. Preferably, the opening 382 is generally cylindrical.

Preferably, the converting assembly 300 includes a means for reducing the friction as the pin 374 rocks in the opening 382 of the follower 380. For example, bearings, such as needle bearings 394 can be adapted to be positioned in the opening 382 of the follower.

Referring now to FIG. 9, another alternative embodiment of a converting assembly 400 is provided, which is similar to the converting assemblies 100, 200, and 300 previously described, except that it includes a planetary 460, a follower 480, and no separate bearing therebetween.

In particular, the planetary 460 has a projection, such as rib 474. In this embodiment, the rib 474 is positioned to intersect with the axis of the central opening 162 (not shown in this view).

The follower 480 comprises: a slot 482 adapted to receive the rib 474, and a means for engaging the pistons 604, 604′. In this embodiment, the means for engaging the piston comprises: a head 484 having piston bore 486 adapted to receive a portion of the pistons 604, 604′, and a means for retaining the piston in the piston bore. This embodiment illustrates, for example, that the means for retaining the piston in the piston bore of the follower comprises: female threads in the piston bore, and corresponding male threads on the ends of the pistons 604, 604′. Again, this embodiment illustrates that the pistons 604, 604′ are not necessarily integrally formed.

In addition, it is to be understood that any of the converting assemblies 100, 200, 300, or 400 can be used to drive a single piston instead to a bi-directional piston such as pistons 604, 604′.

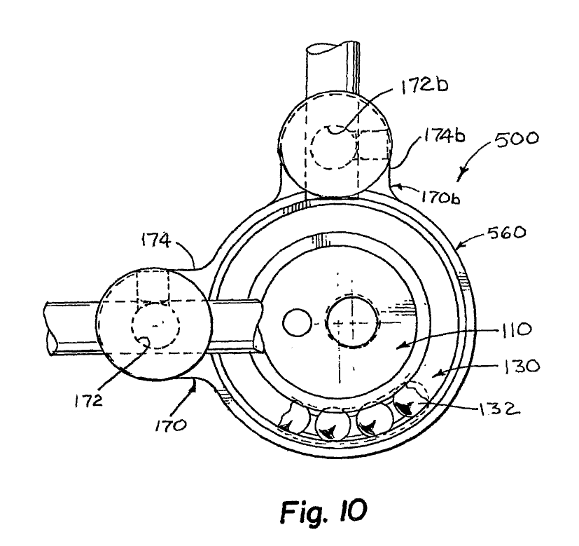

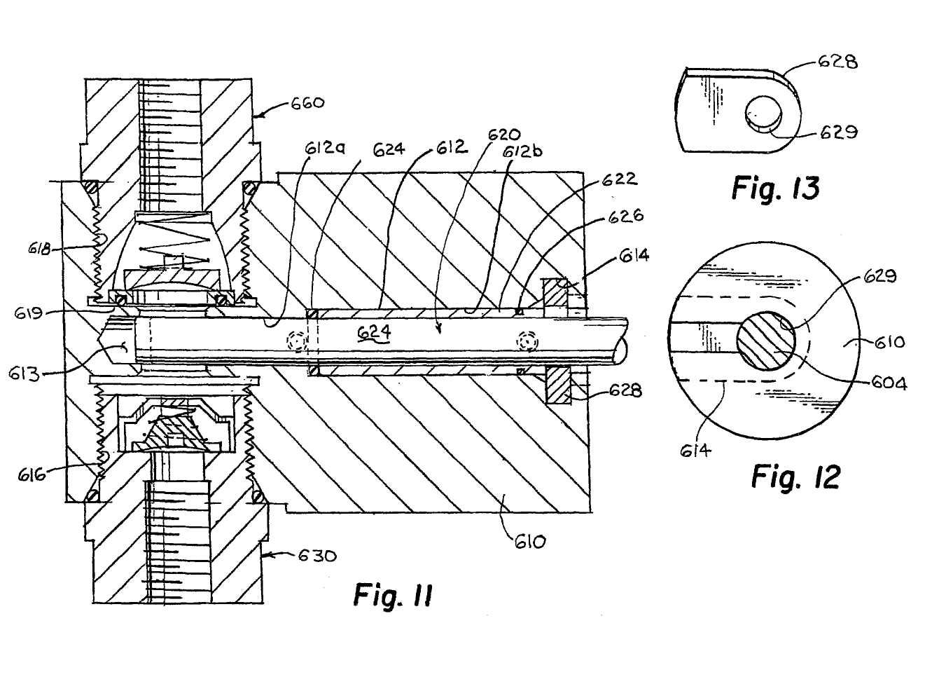

FIG. 10 of the drawing illustrates that the planetary, such as a converting assembly 500 can use a planetary 560 having a second follower connector 170b. As shown in FIG. 10, the second follower connector 170b can be identical in all respects to the first follower connector 170, as previously shown in FIGS. 3-5 and described with respect thereto. It is also contemplated, however, that the follower connector 170b can be the same or different than the follower connector 170.

Preferably, the second follower connector 170b has a third opening 172b, which can be similar to the opening 172 in the first follower connector 170. Most preferably, the third opening in the planetary is eccentrically located relative to the generally cylindrical opening in the planetary for the plurality of bearings. Most preferably, the third opening 172b in the planetary 560 is generally cylindrical. Most preferably, the third opening 172b in the planetary 560 is located the same eccentric distance from the generally cylindrical opening 170 and at 90 degrees relative to the second opening. As will be appreciated by those skilled in the art in considering the circular motion of the planetary 560, a component of the circular motion can converted through the first follower connector 170 to drive a piston in a first direction (e.g., horizontal), and a component of the circular motion can be converted through the second follower connector 170b to drive a piston in a second direction (e.g., vertical). It is believed that where the first direction and second direction are orthogonal (i.e., at 90 degrees to one another), the sinusoidal transfer of the circular motion to linear motion is perfectly out of phase and the transfers can be simultaneous without locking up of the various motions involved.

FIG. 11 illustrates the pump 600, which is also representative of the pump 600′, except for the orientation of the pump. The pump 600 has a generally cylindrical body 610, which includes: a piston bore 612 adapted to receive a piston 604 and bushing assembly 620; a pumping chamber 613; a slot 614 adapted to slidingly receive a piston bushing retainer 628; a first threaded port 616 adapted to receive a suction valve assembly 630; and a second threaded port 618 adapted to receive a discharge valve assembly 660.

The piston bore 612 has a relatively small diameter potion 612a that is barely larger than the piston 604 positioned therein, and a relatively larger diameter portion 612b adapted to receive a piston bushing assembly 620. The piston bushing assembly 620 includes a bushing 622 between the piston bore 612b and the piston 604. Preferably, the piston bushing assembly includes a sealing ring 624 which is positioned at the bottom of the larger diameter portion 612b. Preferably, the piston bushing assembly 620 also has a sealing o-ring 626 positioned toward an upper end thereof.

As shown in FIGS. 11 and 12, according to an aspect of the invention, the retainer 628 is slidingly positioned in slot 614 for conveniently retaining the piston bushing assembly 620. This simple sliding insertion of the retainer 628 into the slot 614 of the pump body 610 securely retains the bushing assembly 620 in the larger diameter portion 612b of the piston bore 612. The piston 604 can reciprocate through the aperture 629 formed in the retainer 628.

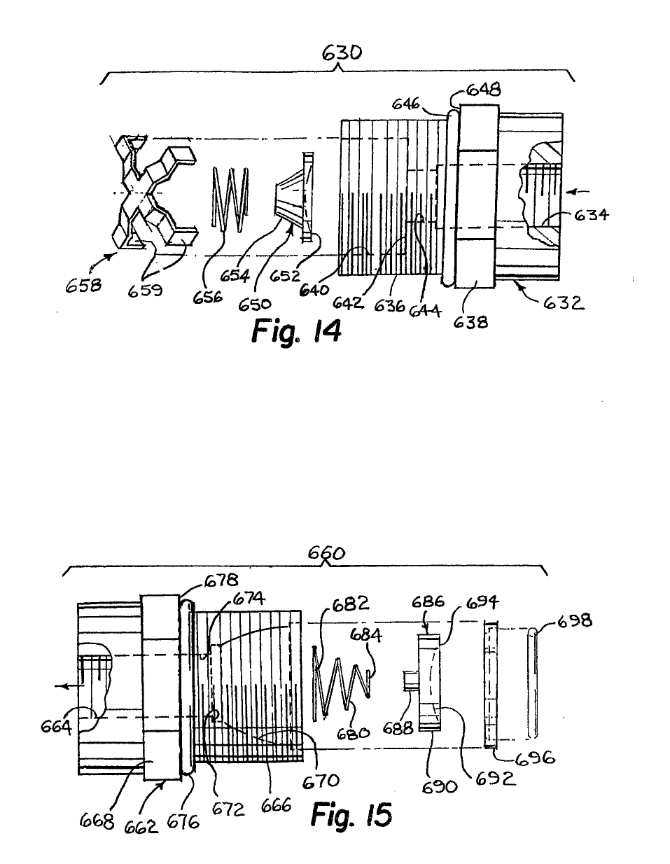

The suction and discharge valve assemblies 630 and 660, respectively, are described in detail with respect to enlarged FIGS. 14 and 15, respectively.

FIG. 14 illustrates the suction valve assembly 630. The suction valve assembly 630 includes a suction valve housing 632. The suction valve housing preferably has an internally threaded bore 634 adapted for receiving a suction valve fitting, such as fitting 602, 602′ (see FIG. 1, not shown in FIG. 14). The suction valve housing 632 also preferably has a male threaded portion 636 and a hex head 638, or other suitable head design, which facilitates screwing the suction valve housing 632 into the first threaded connector 616 of the pump body 610 as shown in FIG. 11. In addition, the suction valve housing 632 has an interior bore 640 ending at shoulder 642, which bore is adapted for receiving a one-way check valve subassembly. A fluid communicating bore 644 extends between the threaded bore 634 and the interior bore 640.

Preferably, the suction valve assembly 630 includes an o-ring 646 positioned adjacent shoulder 648 of the hex head 638. When the suction valve housing 632 is threaded into the first threaded port 616, the o-ring 644 helps seal the shoulder 648 of the suction valve housing 632 against an exposed rim of the first threaded port 616, as shown in FIG. 11.

Referring back to FIG. 14, the suction valve assembly includes a poppet 650, the poppet having a disk shaped base portion 652 and a conical guide potion 654. The suction valve assembly 630 also includes a coil spring, such as cylindrical coil spring 656, and retainer clip 658. The retainer clip 658 has a plurality of legs 659. Fluid can pass between the legs 659 of the retaining clip 658. The coil spring 656 biases the base portion 652 of the poppet 650 against the shoulder 642 of the bore 640. A fluid pressure differential from one direction pushes the poppet 650 off the shoulder 642, opening fluid flow, whereas a fluid pressure differential from the opposite direction pushed the poppet 650 against the shoulder 642, closing the fluid flow.

FIG. 15 illustrates the discharge valve assembly 660 according to the invention. The discharge valve assembly 660 includes a discharge valve housing 662. The discharge valve housing 662 preferably has an internally threaded bore 664 adapted for receiving a discharge valve fitting, such as fitting 606, 606′ (see FIG. 1, not shown in FIG. 15). The discharge valve housing 662 also preferably has a male threaded portion 666 and a hex head 668, or other suitable head design, which facilitates screwing the discharge valve housing 662 into the second threaded connector 618 of the pump body 610 as shown in FIG. 11. In addition, the discharge valve housing 662 has an interior bell shaped cavity 670 ending at shoulder 672, which cavity is adapted for receiving a one-way check valve subassembly. A fluid communicating bore 674 extends between the threaded bore 664 and the interior bore 670.

Preferably, the discharge valve assembly 660 includes an o-ring 676 positioned adjacent shoulder 678 of the hex head 668. When the discharge valve housing 662 is threaded into the second threaded port 618, the o-ring 676 helps seal the shoulder 678 of the suction valve housing 662 against an exposed rim of the second threaded port 618, as shown in FIG. 11.

Referring back to FIG. 15, the discharge valve assembly 660 includes a spring, such as conical coil spring 680. The coil spring has a larger-diameter base portion 682 and a smaller-diameter head portion 684. The larger-diameter base of the conical coil spring 680 engages the shoulder 672 of the interior bell shaped cavity 670. The smaller-diameter end portion 684 of the conical coil spring 680 engages a poppet 686.

The poppet 686 preferably has a central cylindrical knob 688 and disk-shaped body portion 690. Most preferably, the disk shaped portion of the poppet has a dome-shaped recess 692 extending to a rim 694. The rim 694 is adapted to land on a washer 696.

The washer 696 has a groove adapted for an o-ring 698. The washer 696 and its o-ring 698 are adapted to land on a rim 619 at the bottom of the threaded bore 618, as shown in FIG. 11.

According to this aspect of the invention, the washer and o-ring provide an improved seal against leakage around the poppet 686 back into the pumping chamber 613.

The invention is described with respect to presently preferred embodiments, but is not intended to be limited to the described embodiments. As will be readily apparent to those of ordinary skill in the art, numerous modifications and combinations of the various aspects of the invention and the various features of the preferred embodiment can be made without departing from the scope and spirit of the invention. It should also be understood, for example, that the function of a single structure described herein can sometimes be performed by more than one part, or the functions of two different structures can be performed by a single or integrally formed part. Especially from manufacturing and cost perspectives, it is preferred to design the device to minimize the number of parts. These costs include not only the costs associated with making the parts, but also the costs of assembly. Preferably, the fewest possible number of parts and steps required to manufacture and assemble the apparatus, the better. The invention is to be defined by the appended claims.

What is claimed is:

1. An apparatus for converting an axial rotational motion of a drive shaft to a linear reciprocating motion to drive a piston, the apparatus comprising:
a. a cam, wherein the cam comprises:
i. a generally cylindrical body portion; and
ii. a drive-shaft connector, wherein the drive-shaft connector is:
1. a threaded connection between the drive shaft and the cam, and
2. located along an eccentric axis of the cam;
b. a plurality of bearings, wherein the plurality of bearings are operatively positioned around the cam; and
c. a planetary, wherein the planetary comprises:
i. a generally cylindrical opening adapted to be operatively positioned around the plurality of bearings; and
ii. a follower connector, wherein the follower connector is adapted to be part of an operable connection between the planetary and the piston.

2. The apparatus according to claim 1, wherein the drive shaft rotates in the opposite direction to the handedness of the threaded connection between the drive shaft and the cam, whereby the rotation of the drive shaft tends to maintain the threaded connection.

3. The apparatus according to claim 2, wherein the cam further comprises: a second bore in the cam, wherein the second bore has an axis that is eccentric to the threaded connection between the drive shaft and the cam, whereby a rod can be inserted into the second bore for knocking and loosening the threaded connection between the drive shaft and the cam.

4. The apparatus according to claim 1, wherein the threaded connection between the drive shaft and the cam comprises: (a) a female threaded bore in the cam; and (b) a male threaded end on the drive shaft, wherein the male threaded end on the drive shaft corresponds to the female threaded bore in the cam.

5. An apparatus for converting an axial rotational motion of a drive shaft to a linear reciprocating motion to drive a piston, the apparatus comprising:
a. a cam, wherein the cam comprises:
i. a generally cylindrical body portion; and
ii. a drive-shaft connector, wherein the drive-shaft connector is:
1. adapted to be part of an operable connection between the drive shaft and the cam, and
2. located along an eccentric axis of the cam;
b. a bearing assembly operatively positioned around the cam, wherein the bearing assembly comprises:
i. a plurality of bearings;
ii. an outer race for the plurality of bearings;
iii. an inner race for the plurality of bearings, wherein the inner race is adapted to be positioned around the cam in an interference fit;
c. a planetary, wherein the planetary comprises:
i. a generally cylindrical opening adapted to be operatively positioned around the bearing assembly, wherein the opening in the planetary is adapted to be positioned around the bearing assembly in an interference fit; and
ii. a follower connector, wherein the follower connector is adapted to be part of an operable connection between the planetary and the piston.

6. The apparatus according to claim 5, wherein the bearing assembly further comprises: a ball cage for the plurality of bearings.

7. The apparatus according to claim 5, wherein the bearing assembly further comprises: a bearing shield.

8. The apparatus according to claim 5, wherein the bearing assembly is operatively positioned around the cam by pressing the cam in an interference fit into the inner race of the bearing assembly.

9. The apparatus according to claim 5, wherein the opening of the planetary is operatively positioned around the bearing assembly by pressing the outer race of the bearing assembly in an interference fit into the opening of the planetary.

10. The apparatus according to claim 5, wherein the opening of the planetary further comprises a lip for assisting in axially retaining the bearing assembly in the opening.

11. The apparatus according to claim 5, wherein the opening of the planetary further comprises a back for assisting in positioning and axially retaining the bearing assembly in the opening.

12. The apparatus according to claim 11, wherein the back of the opening of the planetary has at least one aperture for assisting in removing the bearing assembly from the opening.

13. The apparatus according to claim 5, wherein the opening of the planetary is operatively positioned around the plurality of bearings by pressing the outer race of the bearing assembly in an interference fit into the opening of the planetary.

14. An apparatus for converting an axial rotational motion of a drive shaft to a linear reciprocating motion to drive a piston, the apparatus comprising:
a. a cam, wherein the cam comprises:
i. a generally cylindrical body portion; and
ii. a drive-shaft connector, wherein the drive-shaft connector is:
1. adapted to be part of an operable connection between the drive shaft and the cam, and
2. located along an eccentric axis of the cam;
b. a plurality of bearings, wherein the plurality of bearings are operatively positioned around the cam;
c. a planetary, wherein the planetary comprises:
i. a generally cylindrical opening adapted to be operatively positioned around the plurality of bearings; and
ii. a follower connector, wherein the follower connector has a generally cylindrical surface adapted to be part of an operable connection between the planetary and the piston;
d. a follower, wherein the follower has a generally cylindrical surface adapted to correspond to the generally cylindrical surface of the follower connector, and wherein the follower is adapted to be part of an operable connection between the planetary and the piston; and
e. a self-lubricating sleeve for reducing friction between the corresponding cylindrical surfaces of the follower connector and the follower.

15. The apparatus according to claim 14, wherein the follower connector of the planetary is eccentrically located relative to the generally cylindrical opening in the planetary for the plurality of bearings and the follower connector and follower have a rocking connection.

16. The apparatus according to claim 15, wherein the planetary further comprises: a second follower connector, wherein the second follower connector is adapted to be part of an operable connection between the planetary and a second piston.

17. The apparatus according to claim 16, wherein the second follower connector of the planetary is located the same eccentric distance from the generally cylindrical opening in the planetary for the plurality of bearings and at 90 degrees relative to the second opening.

18. The apparatus according to claim 16, wherein the second follower connector is adapted to be part of an operable connection between the planetary and a second piston, wherein the axes of the pistons are not parallel to one another.

19. The apparatus according to claim 18, wherein the angle between the non-parallel axes of the pistons is 90 degrees.

20. The apparatus according to claim 16, wherein the follower connector is a substantially cylindrical second opening in the planetary.

21. The apparatus according to claim 20, wherein the follower connector is a substantially cylindrical projection on the planetary.

22. The apparatus according to claim 20, wherein the follower comprises:
a. a substantially cylindrical pin that is adapted to be received in the second opening of the planetary; and
b. means for engaging a portion of the piston.

23. The apparatus according to claim 22, wherein the means for engaging the piston comprises:
a. a head having piston bore adapted to receive a portion of the piston; and
b. a means for retaining the piston in the piston bore.

24. The apparatus according to claim 23, wherein the means for retaining the piston in the piston bore of the follower comprises:
a. a threaded bore in the head perpendicular to the piston bore; and
b. a screw adapted to tighten against the potion of the piston positioned in the piston bore.

25. The apparatus according to claim 23, wherein the means for retaining the piston in the piston bore of the follower comprises:
a. female threads in the piston bore; and
b. corresponding male threads on the end of the piston.

26. An apparatus for converting an axial rotational motion of a drive shaft to a linear reciprocating motion to drive a piston, the apparatus comprising:
a. a cam, wherein the cam comprises:
i. a generally cylindrical body portion; and
ii. a drive-shaft connector, wherein the drive-shaft connector is:
1. adapted to be part of an operable connection between the drive shaft and the cam, and
2. located along an eccentric axis of the cam;
b. a plurality of bearings, wherein the plurality of bearings are operatively positioned around the cam;
c. a planetary, wherein the planetary comprises:
i. a generally cylindrical opening adapted to be operatively positioned around the plurality of bearings; and
ii. a follower connector, wherein the follower connector has a generally cylindrical surface adapted to be part of an operable connection between the planetary and the piston;
d. a follower, wherein the follower has a generally cylindrical surface adapted to correspond to the generally cylindrical surface of the follower connector, and wherein the follower is adapted to be part of an operable connection between the planetary and the piston; and
e. a plurality of needle bearings for reducing friction between the corresponding cylindrical surfaces of the follower connector and the follower.

27. A fluid pump comprising:
a. a piston;
b. a bushing adapted for the piston;
c. a bushing retainer having an aperture through which the piston can reciprocate;
d. a pump body defining:
i. a pumping chamber having a first port adapted to receive a suction valve assembly and a second port adapted to receive a discharge valve assembly;
ii. a piston bore communicating with the pumping chamber, the piston bore adapted to receive the piston and the bushing; and
iii. a slot adapted to slidingly receive the bushing retainer to securely retain the bushing in the piston bore of the pump body.

28. The fluid pump according to claim 27, wherein the bushing is part of a bushing assembly comprising: a sealing ring toward the bottom of the piston bore and a sealing ring toward the upper end of the piston bore.

29. The fluid pump according to claim 27, further comprising a discharge valve assembly, wherein the discharge valve assembly comprises:
a. a housing defining an interior cavity ending at a shoulder;
b. a coil spring positioned in the cavity of the housing to engage the shoulder of the cavity;
c. a poppet valve having a disk shaped body portion with a rim, the poppet valve positioned to engage the coil spring;
d. a washer having a groove formed therein, wherein the washer is positioned to engage the rim of the poppet valve; and
e. an o-ring positioned adjacent the groove of the washer, whereby the washer and the o-ring are adapted to land on a corresponding rim of the second port of the fluid pump.

30. A discharge valve assembly for a fluid pump, the discharge valve assembly comprising:
a. a housing defining an interior cavity ending at a shoulder;
b. a coil spring positioned in the cavity of the housing to engage the shoulder of the cavity;
c. a poppet valve having a disk shaped body portion with a rim, the poppet valve positioned to engage the coil spring;
d. a washer having a groove formed therein, wherein the washer is positioned to engage the rim of the poppet valve; and
e. an o-ring positioned adjacent the groove of the washer, whereby the washer and the o-ring are adapted to land on a corresponding rim of a discharge port of the fluid pump.

31. The discharge valve assembly according to claim 30, wherein the housing has an internally threaded bore adapted for receiving a discharge valve fitting.

32. The discharge valve assembly according to claim 30, wherein the housing has a male threaded portion adapted for screwing the discharge valve housing into a threaded connector of the discharge port of the fluid pump.

33. The discharge valve assembly according to claim 30, wherein the cavity is bell shaped.

34. The discharge valve assembly according to claim 30, wherein the coil spring is generally conical in shape having a larger-diameter base portion and a smaller-diameter head portion, wherein the larger-diameter base portion engages the shoulder of the cavity and the smaller-diameter head portion engages the poppet.

35. The discharge valve assembly according to claim 34, wherein the poppet has a central cylindrical knob for engaging the smaller-diameter head portion of the coil spring.

36. An apparatus for pumping a fluid, the apparatus comprising:
a. a pump, wherein the pump comprises:
i. a piston;
ii. a bushing adapted for the piston;
iii. a bushing retainer having an aperture through which the piston can reciprocate;
iv. a pump body defining:
1. a pumping chamber having a first port adapted to receive a suction valve assembly and a second port adapted to receive a discharge valve assembly;
2. a piston bore communicating with the pumping chamber, the piston bore adapted to receive the piston and the bushing; and
v. a slot adapted to slidingly receive the bushing retainer to securely retain the bushing in the piston bore of the pump body; and
b. a motion converting apparatus for converting an axial rotational motion of a drive shaft to a linear reciprocating motion to drive the piston of the pump, wherein the motion converting apparatus comprises:
i. a cam, wherein the cam comprises:
1. a generally cylindrical body portion; and
2. a drive-shaft connector, wherein the drive-shaft connector is:
a. adapted to be part of an operable connection between the drive shaft and the cam, and
b. located along an eccentric axis of the cam;
ii. a plurality of bearings, wherein the plurality of bearings are operatively positioned around the cam; and
iii. a planetary, wherein the planetary comprises:
1. a generally cylindrical opening adapted to be operatively positioned around the plurality of bearings; and
2. a follower connector, wherein the follower connector is adapted to be part of an operable connection between the planetary and the piston.
